(19) United States
(12) Patent Application Publication
(10) Pub. No.: US 2019/0392118 A1
(43) Pub. Date: Dec. 26, 2019

(54) Blockchain Version Control

(71) Applicant: ADP, LLC, Roseland, NJ (US)

(72) Inventors: Guy James Elden, Parsippany, NJ (US); Mitchel Jon Maio, Moorpark, CA (US); James Caldwell Ford, Orleans, MA (US)

(21) Appl. No.: 16/013,901

(22) Filed: Jun. 20, 2018

(51) Int. Cl. G06F 21/10; H04L 29/06; H04L 9/06

(52) U.S. Cl. CPC G06F 21/105; H04L 63/102; H04L 2463/101; H04L 2209/38; H04L 9/0637

(57) ABSTRACT

A method, computer system, and computer program product are provided for controlling access to a licensed software application. A blockchain-based version control system receives an access request from a user that requests access to the licensed software application. The version control system determines whether a user has accepted license terms for a current version of the licensed software application by querying a version control blockchain. Responsive To determining that the user has not accepted the license terms for the current version of the licensed software application, the version control system presents the user with a clickwrap agreement requiring the user to accept license terms for the current version of the licensed software application. Responsive to receiving acceptance of the license terms from the user, the user's acceptance of the license terms for the current version of the licensed software application is recorded in the version control blockchain.

### BACKGROUND INFORMATION

### 1. Field

The present disclosure relates to use of payroll smart contracts implemented solely in a computer network for use with distributed ledgers.

### 2. Background

A clickwrap agreement (also known as a “clickthrough” agreement or clickwrap license) is a common type of agreement often used in connection with software licenses. Such forms of agreement are mostly found on the Internet, as part of the installation process of many software packages, or in other circumstances where an agreement is sought using electronic media. The name “clickwrap” came from the use of “shrink wrap contracts” commonly used in boxed software purchases, which “contain a notice that by tearing open the shrinkwrap, the user assents to the software terms enclosed within.”

The content and form of clickwrap agreements vary widely. Most clickwrap agreements require the end-user to manifest his or her assent by clicking an “ok” or “agree” button on a dialog box or pop-up window. A user indicates rejection by clicking “cancel” or closing the window. Upon rejection, the user cannot use or purchase the product or service.

However, for a company to effectively use and maintain the enforceability of clickwrap agreements, accurate and often extensive record-keeping is mandatory. Record-keeping is compounded when a new version of licensed software is released. Employing some kind of version control and tracking is vital. Companies must track when new versions of the software are released; the identity of the user; and when the user assented to the click cwrap agreement as well as what version of the software was in effect at that time.

### SUMMARY

The illustrative embodiments provide for a method for controlling access to a licensed software application. A computer system receives an access request from a user that requests access to the licensed software application. The computer system determines whether a user has accepted license terms for a current version of the licensed software application by querying a version control blockchain. Responsive to determining that user has not accepted the license terms for the current version of the licensed software application, the computer system presents the user with a clickwrap agreement requiring the user to accept license terms for the current version of the licensed software application. Responsive to receiving acceptance of the license terms from the user, the computer system records the user's acceptance of the license terms for the current version of the licensed software application in the version control blockchain.

The illustrative embodiments also contemplate a computer configured to execute program code which implements this method. The illustrative embodiments also contemplate a non-transitory computer-recordable storage medium storing program code, which, when executed, implements this method.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a distributed ledger in the form of a blockchain in accordance with an illustrative embodiment;

FIG. 2 is an illustration of a first step in creating a blockchain in accordance with an illustrative embodiment;

FIG. 3 is an illustration of a second step in creating a blockchain in accordance with an illustrative embodiment;

FIG. 4 is an illustration of a third step in creating a blockchain in accordance with an illustrative embodiment;

FIG. 5 is an illustration of a fourth step in creating a blockchain in accordance with an illustrative embodiment;

FIG. 6 is an illustration of a fifth step in creating a blockchain in accordance with an illustrative embodiment;

FIG. 7 is an illustration of a sixth step in creating a blockchain in accordance with an illustrative embodiment;

FIG. 8 is an illustration of a creation of a smart contract in accordance with an illustrative embodiment;

FIG. 9 is an illustration of an operation of a smart contract in accordance with an illustrative embodiment;

FIG. 10 is a block diagram of an execution environment for executing a smart contract stored on a blockchain in accordance with an illustrative embodiment;

FIG. 11 is a block diagram of a blockchain-based version control environment in accordance with an illustrative embodiment;

FIG. 12 is a flowchart of a process for controlling access to a licensed software application in accordance with an illustrative embodiment; and

FIG. 13 is a block diagram of a data processing system in accordance with an illustrative embodiment.

### DETAILED DESCRIPTION

The illustrative embodiments recognize and take into account that smart contracts on blockchains have not been used to control access to a licensed software application. In other words, so far, no one has attempted or designed a version control system that utilizes the underlying technology of blockchains and smart contracts to create an open and secure version control system.

A distributed ledger, as used throughout this document, refers to a computer-only technology that enables the distributed recordation of transactions through a distributed ledger maintained by a network of computers. A blockchain is an example of a distributed ledger. BITCOIN® is an example of a blockchain technology application.

A blockchain is a type of distributed ledger, which includes digitally recorded, unmodifiable data in packages called blocks. A distributed ledger is a consensus of replicated, shared, and synchronized digital data geographically spread across multiple computers which may be in different sites, countries, and/or institutions maintained by many different parties. A distributed ledger can be public, such as BITCOIN®, where there is no limitation on who may participate in the network, or private, where only approved parties are permitted to participate in the network.

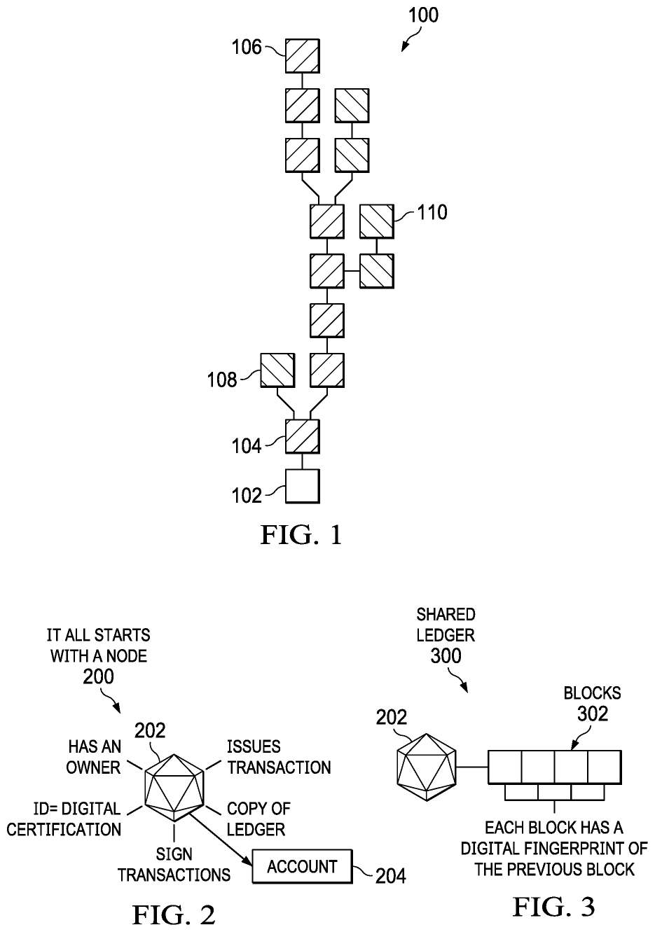

FIG. 1 is an illustration of a distributed ledger in the form of a blockchain depicted in accordance with an illustrative embodiment. Blockchain 100 is a blockchain, which is a specific implementation of a distributed ledger. Blockchain 100 is described to introduce blockchain concepts.

Blockchain 100 starts with genesis block 102. Blocks indicated with a right-leaning hash, such as block 104 or leaf block 106, are part of the main chain. Blocks with a left leaning hash, such as block 108 or block 110, exist outside of blockchain 100.

Thus, blockchain 100 is a heaviest path from root block 102 to leaf block 106 through the entire block tree. The “heaviest” path through the block tree, i.e. the path that has had the most computation done upon it, is conceptually identified as blockchain 100. Identifying blockchain 100 in this manner allows a decentralized consensus to be achieved for the state of blockchain 100.

Stated more formally, a blockchain is a distributed database that maintains a continuously growing list of ordered records called blocks. Each block contains a timestamp and a link to a previous block, with the hash of the prior block linking the two. By design, blockchains are inherently resistant to modification of the data because, once recorded, the data in a block cannot be altered retroactively. Through the use of a peer-to-peer network and one or more distributed timestamping servers, a blockchain database may be managed autonomously. Thus, blockchains may be used to provide an open, distributed ledger that can record transactions between parties efficiently and in a verifiable and permanent way.

Distributed ledgers, and blockchains in particular, are secure by design. Blockchains have a high byzantine fault tolerance. Thus, a decentralized consensus can be achieved with a blockchain. The first blockchain was created by Satoshi Nakamoto in 2008 and implemented the following year as a core component of the digital currency BITCOIN®, where it serves as the public ledger for all transactions. BITCOIN® was the first digital currency to solve the double spending problem, without the use of a trusted authority or central server.

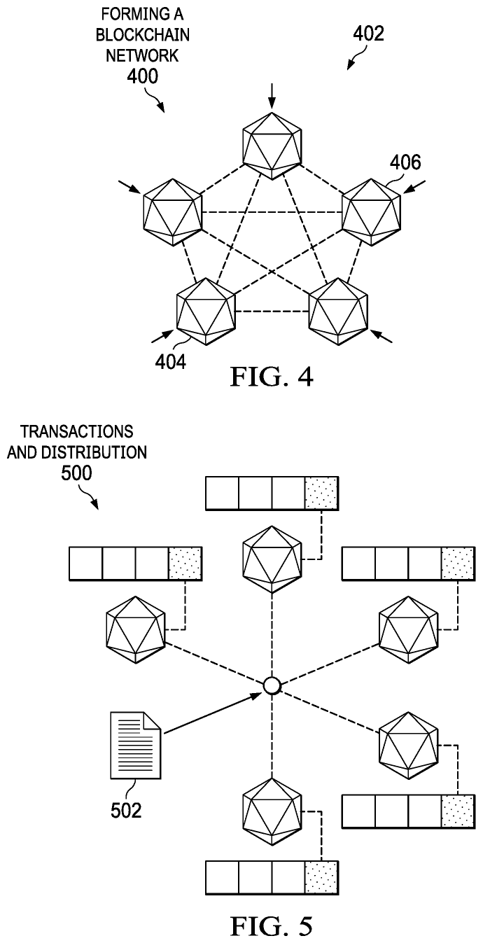

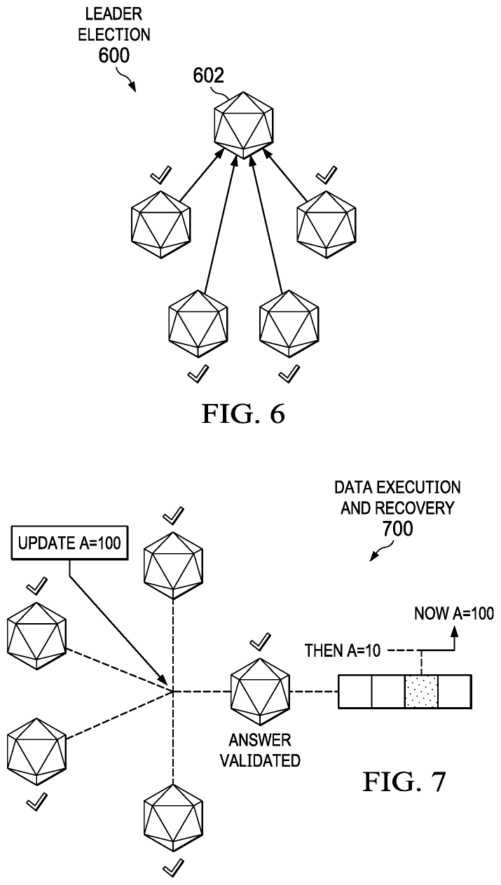

FIG. 2 through FIG. 7 should be considered together. FIG. 2 is an illustration of a first step in creating a blockchain in accordance with an illustrative embodiment. FIG. 3 is an illustration of a second step in creating a blockchain depicted in accordance with an illustrative embodiment. FIG. 4 is an illustration of a third step in creating a blockchain depicted in accordance with an illustrative embodiment. FIG. 5 is an illustration of a fourth step in creating a blockchain depicted in accordance with an illustrative embodiment. FIG. 6 is an illustration of a fifth step in creating a blockchain depicted in accordance with an illustrative embodiment. FIG. 7 is an illustration of a sixth step in creating a blockchain depicted in accordance with an illustrative embodiment. FIG. 2 through FIG. 7 may be implemented on a computer or on multiple computers in a network environment. FIG. 2 through FIG. 7 address a technical problem that only exists in computer programming and execution. As used throughout FIG. 2 through FIG. 7, common reference numerals refer to common objects in these figures.

In operation 200 shown in FIG. 2, node 202 creates account 204 that contains the initial data for the distributed ledger 100 in FIG. 1. Account 204 is a state object recorded in the shared ledger that represents the identity of agents that can interact with the ledger. Account 204 includes an owner, a digital certificate identification, and a copy of a ledger. Node 202 may issue transactions from account 204 for interacting with the blockchain. Node 202 may sign transactions and inspect the blockchain and its associated state. The state of a blockchain is the combined state of all nodes that have interacted with the blockchain. Node 202 may issue transactions from account 204 for interacting with the blockchain.

In operation 300 shown in FIG. 3, node 202 collates transactions and distributions into blocks 302, and adds blocks 302 to the shared ledger. Blocks 302 function as a journal, recording a series of transactions together with the previous block and an identifier for the final state of the blockchain. Blocks 302 are chained together using a cryptographic hash as a means of reference—each block in the shared ledger has a digital fingerprint of the previous block. In this manner, it is not possible to alter previous blocks without being detected.

In operation 400 shown in FIG. 4, blockchain network 402 is formed. Blockchain network 402 may include multiple blockchains such as those shown in FIG. 2 or FIG. 3. Each node, such as node 404 or node 406, has its own blockchain.

In operation 500 shown in FIG. 5, transaction 502 is issued from an account, such as account 204 in FIG. 2. Transaction 502 is an instruction constructed by a node, such as node 202 in FIG. 2, and cryptographically-signed by an account, such as account 204.

There are two types of transactions: transactions that result in message calls, and transactions that result in the creation of new agent accounts, i.e., “contract creation” transactions. Transactions that result in message calls contain data specifying input data for the message.

Transactions and distributions are collated into blocks that are added to the blockchain by the various nodes. The blockchain is synchronized across the various nodes. Thus, each node in blockchain network 402 of FIG. 4 adds identical blocks to a local copy of the blockchain.

In operation 600 shown in FIG. 6, leader election takes place. In this operation, leader node 602 is elected. Leader node 602 takes priority for deciding which information is the most accurate or up-to-date. Identifying information by leader node 602, and validating this information by other nodes, allows a decentralized consensus to be achieved throughout the network for the state of blockchain 100 in FIG. 1.

In operation 700 shown in FIG. 7, data execution and recovery takes place. A query regarding data stored in one or more of the nodes may return a validated answer regarding contents in the blocks.

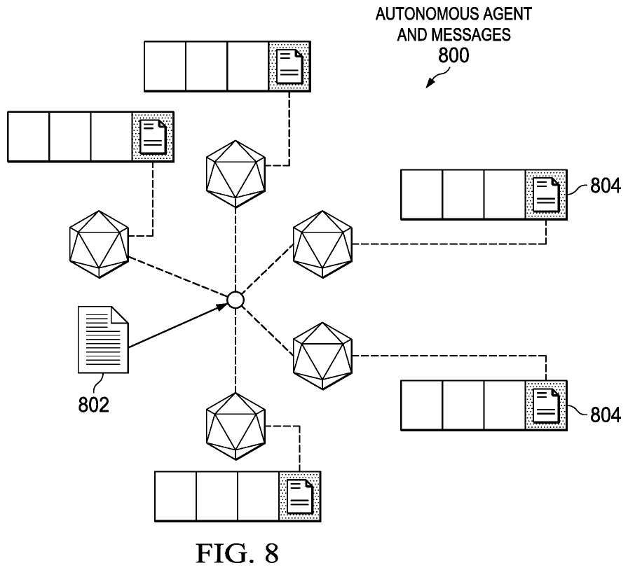

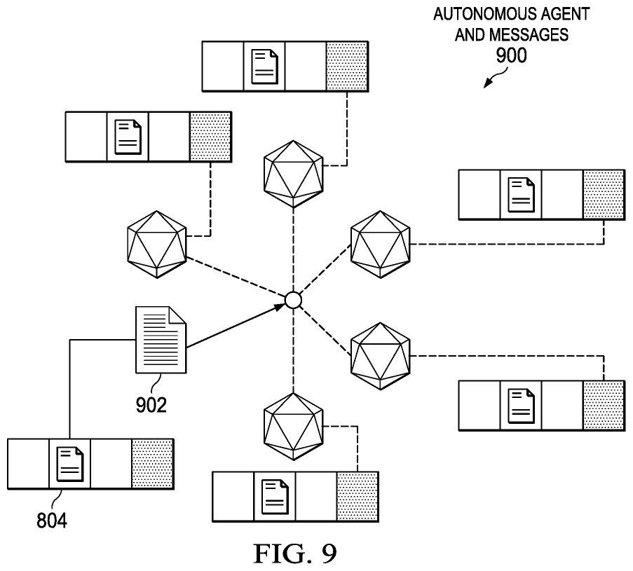

FIG. 8 and FIG. 9 should be considered together. FIG. 8 is an illustration of a step in creating a blockchain having a smart contract therein depicted in accordance with an illustrative embodiment. FIG. 9 is an illustration of a step in creating a blockchain using a smart contract within a blockchain depicted in accordance with an illustrative embodiment. FIG. 8 and FIG. 9 may be implemented on a computer or on multiple computers in a network environment.

In operation 800 shown in FIG. 8, transaction 802 and distributions are added to the various nodes. Thus, blocks are added to each node. As indicated above, there are two types of transactions: transactions that result in message calls, and transactions that result in the creation of new agent accounts.

Transaction 802 is a cryptographically-signed instruction constructed by a node, such as node 202 in FIG. 2. Transaction 802 results in the creation of smart contract 804. In contrast to data contained in message call transactions, such as transaction 502 in FIG. 5, transaction 802 contains data specifying initialization code for smart contract 804. Each node in a blockchain network executes this initialization code to incorporate smart contract 804 into the blockchain. In this illustrative example, the initialization code is executed at account creation and discarded immediately thereafter. The initialization code retrieves a second code fragment that executes each time the account receives a message call (either through a transaction or due to the internal execution of code).

Smart contract 804 is a type of account that is stored on the blockchain; it is a collection of code, i.e. functions, and data, i.e. state, that resides at a specific address on the blockchain. Smart contract 804 is not associated with an external node, but rather is a notional object existent only within the blockchain execution environment. Smart contract 804 has direct control over its own state and storage memory to preserve persistent state variables. When referenced by a message or transaction, smart contract 804 executes its associated functions.

In operation 900 shown in FIG. 9, smart contract 804 generates message 902. In a contract account, every time the contract account receives a message, its code activates. Message 902 is an instruction constructed by smart contract 804 in response to receiving a message. Message 902 is a sort of “virtual transaction” sent by code from one account to another. Message 902 can specify input data that results in message calls for other accounts, allowing smart contract 804 to read and write to internal storage. Alternatively, message 902 can contain data specifying initialization code, allowing smart contract 804 to create additional smart contracts.

In this illustrative example, code for smart contract 804 can be executed as part of state transition and block validation. If a transaction is added into a block, the code execution spawned by that transaction will be executed by all nodes that download and validate the block.

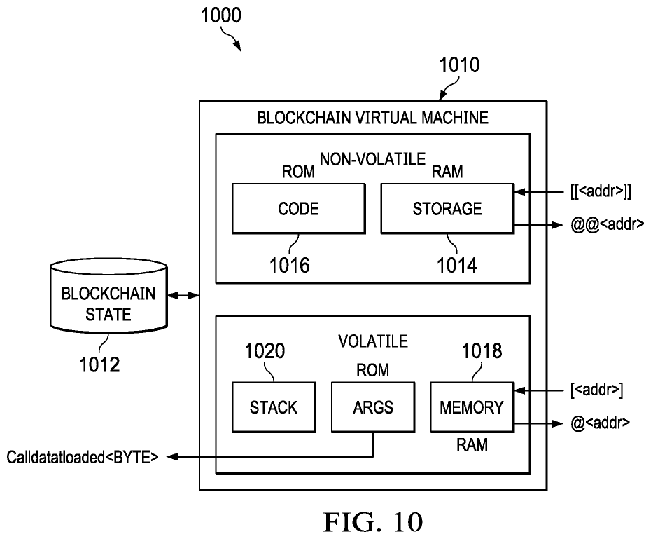

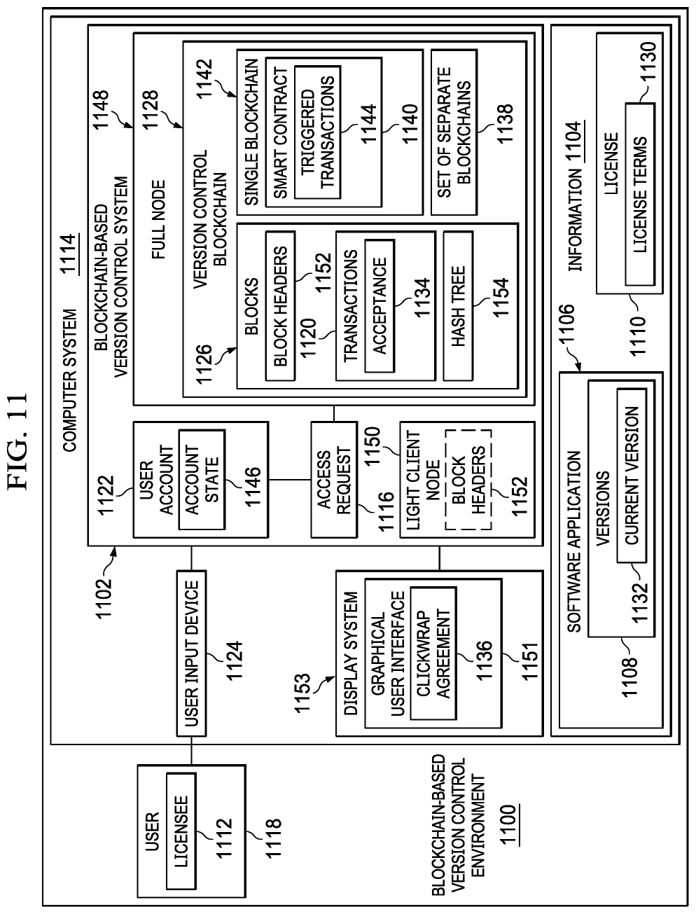

With reference next to FIG. 10, a block diagram of an execution environment for executing a smart contract stored on the blockchain is depicted in accordance with an illustrative embodiment.

Blockchain environment 1000 includes a number of different components. As depicted, blockchain environment 1000 includes blockchain virtual machine 1010 and blockchain state 1012.

Blockchain virtual machine 1010 is responsible for internal account state and transaction computation for the blockchain. Blockchain virtual machine 1010 performs state transitions for smart contracts. In this illustrative example, blockchain virtual machine 1010 has a stack-based architecture that uses a last-in, first-out stack. Blockchain virtual machine 1010 executes transactions recursively, computing the system state and the machine state for each loop. Blockchain virtual machine 1010 includes non-volatile and volatile components.

Storage 1014 is non-volatile and is maintained on the blockchain as part of the system state. Every smart contract on the blockchain has its own storage. Storage 1014 preserves all the state variables for the smart contract that do not change between the function calls.

Code 1016 are instructions that formally specify the meaning and ramifications of a transaction or message to an account. Blockchain virtual machine 1010 executes code 1016 in response to receiving a message call. In contrast to standard architecture where program code is stored in generally-accessible memory, code 1016 is stored separately in a virtual ROM that cannot be changed after construction.

Memory 1018 is volatile and is cleared between external function calls. Memory 1018 stores temporary data; for instance, function arguments, local variables, and storing return values. Stack 1020 is used to hold temporary values when conducting calculations in blockchain virtual machine 1010.

Blockchain environment 1000 includes blockchain state 1012. Blockchain virtual machine 1010 relies on blockchain state 1012 for execution of certain instructions. Blockchain state 1012 can include a mapping between blockchain addresses, i.e., accounts and account states. Blockchain state 1012 may not be stored on the blockchain, but rather in a data structure on a backend state database that maintains the mapping.

With reference now to FIG. 11, a block diagram of a blockchain-based version control environment is depicted in accordance with an illustrative embodiment. As depicted, blockchain-based version control environment 1100 includes blockchain-based version control system 1102.

Blockchain-based version control system 1102 may take different forms. For example, blockchain-based version control system 1102 may be selected from one of an employee information system, a research information system, a sales information system, an accounting system, a payroll system, a human resources system, or some other type of information system that stores and provides access to information 1104.

Information 1104 can include at least one of software application 1106 and information about software application 1106. Software application 1106 may exist in one or more versions 1108 corresponding to unique states and new developments in software application 1106.

Information 1104 about software application 1106 can include license 1110. License 1110 is a contractual agreement governing the use or redistribution of software application 1106 by licensee 1112.

As used herein, the phrase “at least one of,” when used with a list of items, means different combinations of one or more of the listed items may be used and only one of each item in the list may be needed. In other words, “at least one of” means any combination of items and number of items may be used from the list, but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Licensee 1112 may be, for example, a corporation, a partnership, a charitable organization, a city, a government agency, or some other suitable type of organization. Licensee 1112 can encompass people who are employed by or associated with such organizations that use software application 1106.

In this illustrative example, blockchain-based version control system 1102 is implemented in computer system 1114. Computer system 1114 is a physical hardware system and includes one or more data processing systems. When more than one data processing system is present, those data processing systems may be in communication with each other using a communications medium. The communications medium may be a network. The data processing systems may be selected from at least one of a computer, a server computer, a workstation, a tablet computer, a laptop computer, a mobile phone, or some other suitable data processing system. The network of data processing systems are nodes within blockchain-based version control system 1102.

Blockchain-based version control system 1102 may be implemented in software, hardware, firmware, or a combination thereof. When software is used, the operations performed by blockchain-based version control system 1102 may be implemented in program code configured to run on hardware, such as a processor unit. When firmware is used, the operations performed by blockchain-based version control system 1102 may be implemented in program code and data and stored in persistent memory to run on a processor unit. When hardware is employed, the hardware may include circuits that operate to perform the operations in blockchain-based version control system 1102.

In the illustrative examples, the hardware may take the form of a circuit system, an integrated circuit, an application-specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, programmable array logic, a field programmable logic array, a field programmable gate array, and other suitable hardware devices. Additionally, the processes may be implemented in organic components integrated with inorganic components and may be comprised entirely of organic components, excluding a human being. For example, the processes may be implemented as circuits in organic semiconductors.

In this illustrative example, blockchain-based version control system 1102 controls access to software application 1106. Blockchain-based version control system 1102 receives access request 1116 from user 1118. User 1118 is a licensee for software application 1106. Access request 1116 is an interaction by user 1118 with blockchain-based version control system 1102 requesting access to software application 1106.

User 1118 may interact with blockchain-based version control system 1102 by issuing transactions 1120, such as access request 1116, via user account 1122. The interaction may be made through user input generated by one or more of user input device 1124, such as, for example, a mouse, a keyboard, a trackball, a touchscreen, a stylus, or some other suitable type of user input device.

User account 1122 is an account in blockchain-based version control system 1102 that allows user 1118 to interact with version control blockchain 1128. Transactions 1120, of which access request 1116 is an example, submitted by user 1118 is cryptographically-signed by user account 1122. Each transaction uniquely identifies the account that submits the transaction. For example, based on the cryptographic signature identifying user account 1122, access request 1116 uniquely identifies user 1118.

Blockchain-based version control system 1102 records transactions 1120 in blocks 1126 of version control blockchain 1128. Blockchain-based version control system 1102 determines whether user 1118 has accepted license terms 1130 for current version 1132 of the licensed software application 1106 by querying one of version control blockchain 1128. In this illustrative example, blockchain-based version control system 1102 can determine that user 1118 has accepted license terms 1130 for current version 1132 by identifying acceptance 1134. Acceptance 1134 is a previous one of transactions 1120, cryptographically-signed by user account 1122, indicating that user 1118 has accepted license terms 1130 for current version 1132.

When acceptance 1134 for current version 1132 is not found in version control blockchains 1128, blockchain-based version control system 1102 determines that user 1118 has not accepted license terms 1130 for current version 1132. Responsive to determining that user 1118 has not accepted license terms 1130 for current version 1132 of the licensed software application 1106, blockchain-based version control system 1102 presents user 1118 with clickwrap agreement 1336. Clickwrap agreement 1336 requires user 1118 to accept license terms 1130 for current version 1132 prior to accessing software application 1106.

Responsive to receiving acceptance 1134 of license terms 1130 from user 1118, blockchain-based version control system 1102 records the user's acceptance 1134 of license terms 1130 for current version 1132 of the licensed software application 1106 in version control blockchain 1128.

In one illustrative example, each of versions 1108 in software application 1106 is associated with a different one of set of separate blockchains 1138. Consequently, each of set of separate blockchains 1138 is associated with a single one of versions 1108. When a new version of software application 1106 is implemented, blockchain-based version control system 1102 simply implements a new one of version control blockchain 1128. Access to current version 1132 is controlled by the corresponding newest one of version control blockchain 1128.

In another illustrative example, each successive one of versions 1108 of the licensed software application 1106 is associated with a different one of smart contract 1140 encoded on version control blockchain 1128. Smart contract 1140 allows blockchain-based version control system 1102 to track acceptance 1134 for multiple versions 1108 in single blockchain 1142. In this illustrative example, blockchain-based version control system 1102 determines whether user 1118 has accepted license terms 1130 for current version 1132 by determining whether smart contract 1140 for current version 1132 authorizes user 1118 to access the licensed software application 1106.

Smart contracts have a number of desirable properties. Execution of the smart contract is managed automatically by the network. Documents are encrypted on a shared ledger that is duplicated many times over on different nodes of the network, ensuring that the data is true and correct. Because smart contracts on distributed ledgers cannot be modified, they provide an immutable record of submitted workflow transactions that is highly resistant to post-transaction changes. Smart contracts automate progression tasks that were previously performed manually, thereby saving time, possibly many hours.

In this illustrative example, smart contract 1140 can include triggered transactions 1144. Triggered transactions 1144 are transactions generated by smart contract 1140 in response to the execution of smart contract 1140.

Triggered transactions 1144 can be transactions that are sent to other nodes in blockchain-based version control system 1102. Triggered transactions 1144 generated by smart contract 1140 can be sent to another smart contract stored in version control blockchain 1128. Triggered transactions 1142 can include message calls to external applications that request the performance of triggered transaction 1142. For example, triggered transactions 1142 can be a transaction that causes user 1118 to be presented with clickwrap agreement 1136.

Continuing with the current example, blockchain-based version control system 1102 uses smart contract 1140 to determine whether user 1118 has accepted license terms 1130 for current version 1132. Responsive to determining that smart contract 1140 for current version 1132 does not authorize user 1118 to access the licensed software application 1106, blockchain-based version control system 1102 executes a set of triggered transactions 1144 indicated by smart contract 1140. Triggered transactions 1144 cause user 1118 to be presented with clickwrap agreement 1136 requiring user 1118 to accept license terms 1130 for current version 1132 of the licensed software application 1106.

In one illustrative example, blockchain-based version control system 1102 displays clickwrap agreement 1136 in graphical user interface 1151 on display system 1153. In this illustrative example, display system 1153 can be a group of display devices. A display device in display system 1153 may be selected from one of a liquid crystal display (LCD), a light emitting diode (LED) display, an organic light emitting diode (OLED) display, and other suitable types of display devices.

In one illustrative example, blockchain-based version control system 1102 determines whether smart contract 1140 for current version 1132 authorizes user 1118 to access licensed application 1106 by identifying user account 1122 from access request 1116. Each transaction submitted to blockchain-based version control system 1102 is cryptographically-signed by the submitting account. Therefore, each transaction uniquely identifies the account from which it was submitted. Access request 1116 is cryptographically-signed by user account 1122. Based on the cryptographic signature in access request 1116, blockchain-based version control system 1102 can identify user account 1122, and consequently user 1118 that submits access request 1116.

Continuing with the current example, responsive to identifying user account 1122, blockchain-based version control system 1102 determines whether account state 1146 of user account 1122 indicates that user 1118 has accepted license terms 1130 for current version 1132 of the licensed software application 1106. User account 1122 is a state object recorded in version control blockchain 1128. Blockchain-based version control system 1102 can set account state 1146 based on acceptance 1134 of versions 1108. For example, upon receiving acceptance 1134, blockchain-based version control system 1102 may set an account balance of account state 1146 equal to a version number of current version 1132.

In one illustrative example, blockchain-based version control system 1102 collects access request 1116, as well as, triggered transactions 1144 into one of blocks 1126. Full node 1148 of blockchain-based version control system 1102 attaches the block to a local copy of version control blockchain 1128. Thereafter, full node 1148 of blockchain-based version control system 1102 publishes the block to other networked nodes in blockchain-based version control system 1102.

In one illustrative example, user account 1122 is light client node 1150. Light client node 1150 allow users in storage-limited or bandwidth-limited environments, such as in applications on a mobile device, to maintain a high-security assurance about a current state of some portion of the state of version control blockchain 1128, or verify the execution of transactions 1120.

In contrast to full node 1148, light client node 1150 downloads only block headers 1152 by default. Block headers 1152 contain root hashes for blocks 1126, enabling light client node 1150 to obtain state and transaction information from full node 1148.

Each of transactions 1120 is hashed and stored in hash tree 1154 of the associated one of blocks 1126. For each one of blocks 1126, all of the transaction hashes in hash tree 1154 are themselves hashed and stored as a root hash as part of block headers 1152.

Block headers 1152 are much smaller than entire blocks. Using a distributed hash table as a database, light client node 1150 can store just block headers 1152 of version control blockchain 1128 and obtain blockchain information, such as acceptance 1134, by communicating with full node 1148.

Continuing with the current example, blockchain-based version control system 1102 identifies user account 1122 from access request 1116. In this illustrative example, user account 1122 is received from light client node 1150.

Blockchain-based version control system 1102 recursively downloads nodes of hash tree 1154 stored at full node 1148 in a blockchain network until user account 1122 is located. Responsive to locating the account of the user, blockchain-based version control system 1102 can determine whether account state 1146 of user account 1122 indicates that user 1118 has accepted license terms 1130 for current version 1132 of the licensed software application 1106.

The illustrative example in FIG. 11 and the examples in the other subsequent figures provide one or more technical solutions that address one or more technical problems that only exists in computers, particularly a network-centric system of computers. Specifically, blockchain-based version control system 1102 provides an immutable record of acceptance 1134. In this manner, the use of blockchain-based version control system 1102 has a technical effect of managing access to the licensed software application 1106 using version control blockchain 1128, thereby reducing time, effort, or both in the accurate and extensive record-keeping necessary to effectively use and maintain the enforceability of clickwrap agreements. In this manner, maintaining the validity of clickwrap agreement 1136 may be performed more efficiently as compared to currently used systems that do not include blockchain-based version control system 1102.

As a result, computer system 1114 operates as a special purpose computer system in which blockchain-based version control system 1102 in computer system 1114 controls access to a licensed software application 1106. Blockchain-based version control system 1102 receives access request 1116 from user 1118 that requests access to the licensed software application 1106. Blockchain-based version control system 1102 determines whether user 1118 has accepted license terms 1130 for current version 1132 of the licensed software application 1106 by querying version control blockchain 1128. Responsive to determining that user 1118 has not accepted license terms 1130 for current version 1132 of the licensed software application 1106, blockchain-based version control system 1102 presents user 1118 with clickwrap agreement 1136 requiring user 1118 to accept license terms 1130 for current version 1132 of the licensed software application 1106. Responsive to receiving acceptance 1134 of license terms 1130 from user 1118, blockchain-based version control system 1102 records the user's acceptance 1134 of license terms 1130 for current version 1132 of the licensed software application 1106 in version control blockchain 1128.

Thus, blockchain-based version control system 1102 transforms computer system 1114 into a special purpose computer system as compared to currently available general computer systems that do not have blockchain-based version control system 1102. Currently used general computer systems do not provide an immutable record of acceptance 1134 of license terms 1130 for different versions 1108 of software application 1106, thereby reducing time, effort, or both in the accurate and extensive record-keeping necessary to effectively use and maintain the enforceability of clickwrap agreements.

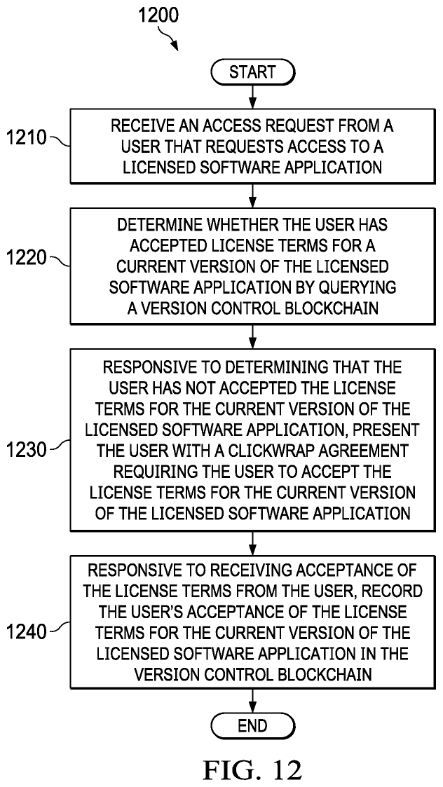

With reference next to FIG. 12, a flowchart of a process for controlling access to a licensed software application is depicted in accordance with an illustrative embodiment. The process of FIG. 12 can be a software process implemented in one or more components of blockchain-based version control system 1102 of FIG. 11.

Process 1200 receives an access request from a user that requests access to a licensed software application (step 1210). Process 1200 determines whether the user has accepted license terms for a current version of the licensed software application by querying a version control blockchain (step 1220).

Responsive to determining that the user has not accepted the license terms for the current version of the licensed software application, process 1200 presents the user with a clickwrap agreement requiring the user to accept the license terms for the current version of the licensed software application (step 1230).

Responsive to receiving acceptance of the license terms from the user, process 1200 records the user's acceptance of the license terms for the current version of the licensed software application in the version control blockchain (step 1240), with the process terminating thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

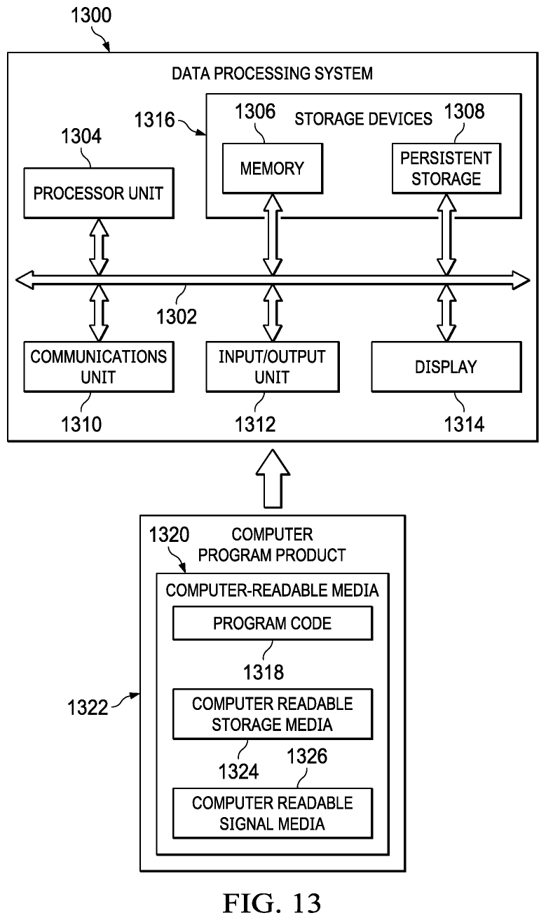

Turning now to FIG. 13, a block diagram of a data processing system is depicted in accordance with an illustrative embodiment. Data processing system 1300 may be used to implement computer system 1114, full node 1148, light client node 1150, and other data processing systems that may be used in blockchain-based version control environment 1100 in FIG. 11.

In this illustrative example, data processing system 1300 includes communications framework 1302, which provides communications between processor unit 1304, memory 1306, persistent storage 1308, communications unit 1310, input/output (I/O) unit 1328, and display 1314. In this example, communications framework 1302 may take the form of a bus system.

Processor unit 1304 serves to execute instructions for software that may be loaded into memory 1306. Processor unit 1304 may be a number of processors, a multi-processor core, or some other type of processor, depending on the particular implementation.

Memory 1306 and persistent storage 1308 are examples of storage devices 1316. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1316 may also be referred to as computer readable storage devices in these illustrative examples. Memory 1306, in these examples, may be, for example, a random access memory or any other suitable volatile or non-volatile storage device. Persistent storage 1308 may take various forms, depending on the particular implementation.

For example, persistent storage 1308 may contain one or more components or devices. For example, persistent storage 1308 may be a hard drive, a solid state hard drive, a flash memory, a rewritable optical disk, a rewritable magnetic tape, or some combination of the above. The media used by persistent storage 1308 also may be removable. For example, a removable hard drive may be used for persistent storage 1308.

Communications unit 1310, in these illustrative examples, provides for communications with other data processing systems or devices. In these illustrative examples, communications unit 1310 is a network interface card.

Input/output unit 1312 allows for input and output of data with other devices that may be connected to data processing system 1300. For example, input/output unit 1312 may provide a connection for user input through at least one of a keyboard, a mouse, or some other suitable input device. Further, input/output unit 1312 may send output to a printer. Display 1314 provides a mechanism to display information to a user.

Instructions for at least one of the operating system, applications, or programs may be located in storage devices 1316, which are in communication with processor unit 1304 through communications framework 1302. The processes of the different embodiments may be performed by processor unit 1304 using computer-implemented instructions, which may be located in a memory, such as memory 1306.

These instructions are referred to as program code, computer usable program code, or computer readable program code that may be read and executed by a processor in processor unit 1304. The program code in the different embodiments may be embodied on different physical or computer readable storage media, such as memory 1306 or persistent storage 1308.

Program code 1318 is located in a functional form on computer readable media 1320 that is selectively removable and may be loaded onto or transferred to data processing system 1300 for execution by processor unit 1304. Program code 1318 and computer readable media 1320 form computer program product 1322 in these illustrative examples. In one example, computer readable media 1320 may be computer readable storage media 1324 or computer readable signal media 1326.

In these illustrative examples, computer readable storage media 1324 is a physical or tangible storage device used to store program code 1318 rather than a medium that propagates or transmits program code 1318.

Alternatively, program code 1318 may be transferred to data processing system 1300 using computer readable signal media 1326. Computer readable signal media 1326 may be, for example, a propagated data signal containing program code 1318. For example, computer readable signal media 1326 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1300 are not meant to provide architectural limitations to the manner in which different embodiments may be implemented. The different illustrative embodiments may be implemented in a data processing system including components in addition to or in place of those illustrated for data processing system 1300. Other components shown in FIG. 13 can be varied from the illustrative examples shown. The different embodiments may be implemented using any hardware device or system capable of running program code 1318.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method of controlling access to a licensed software application, the method comprising:
receiving an access request from a user that requests access to the licensed software application;
determining whether a user has accepted license terms for a current version of the licensed software application by querying a version control blockchain;
responsive to determining that user has not accepted the license terms for the current version of the licensed software application, presenting the user with a clickwrap agreement requiring the user to accept license terms for the current version of the licensed software application; and
responsive to receiving acceptance of the license terms from the user, recording the user's acceptance of the license terms for the current version of the licensed software application in the version control blockchain.

2. The method of claim 1, wherein each successive version of the licensed software application is associated with a separate version control blockchain.

3. The method of claim 1, wherein each successive version of the licensed software application is associated with a different smart contract encoded on the version control blockchain, wherein determining whether the user has accepted license terms for the current version further comprises:
determining whether a smart contract for the current version authorizes the user to access the licensed software application.

4. The method of claim 3, wherein presenting the user with a clickwrap agreement in response to determining that user has not accepted the license terms for the current version further comprises:
responsive to determining that the smart contract for the current version does not authorize the user to access the licensed software application, executing a set of resulting transactions indicated by the smart contract to present the user with the clickwrap agreement requiring the user to accept license terms for the current version of the licensed software application.

5. The method of claim 3, wherein determining whether the smart contract for the current version authorizes the user to access the licensed software application further comprises:
identifying an account of the user from the access request; and
responsive to identifying the account of the user, determining whether an account state for the account of the user indicates that the user has accepted license terms for the current version of the licensed software application.

6. The method of claim 1 further comprising:
collecting the access request and a set of resulting transactions into a workflow block;
attaching the workflow block to a local copy of the blockchain; and
publishing the workflow block to the blockchain-based workflow system.

7. The method of claim 1 further comprising:
identifying an account of the user from the access request, wherein the account of the user is a light client account capable of execution on a mobile device; and
wherein querying the version control blockchain further comprises:
recursively downloading nodes of a state root hash tree stored at a node in a blockchain network until the account of the user is located; and
responsive to locating the account of the user, determining whether an account state for the account of the user indicates that the user has accepted license terms for the current version of the licensed software application.

8. A computer system comprising:
a hardware processor; and
a blockchain-based version control system in communication with the hardware processor, wherein the blog chain version control system is configured:
to receive an access request from a user that requests access to the licensed software application;
to determine whether a user has accepted license terms for a current version of the licensed software application by querying a version control blockchain;
responsive to determining that user has not accepted the license terms for the current version of the licensed software application, to present the user with a clickwrap agreement requiring the user to accept license terms for the current version of the licensed software application; and
responsive to receiving acceptance of the license terms from the user, to record the user's acceptance of the license terms for the current version of the licensed software application in the version control blockchain.

9. The computer system of claim 8, wherein each successive version of the licensed software application is associated with a separate version control blockchain.

10. The computer system of claim 8, wherein each successive version of the licensed software application is associated with a different smart contract encoded on the version control blockchain, wherein in determining whether the user has accepted license terms for the current version, the computer system is further configured:
to determine whether a smart contract for the current version authorizes the user to access the licensed software application.

11. The computer system of claim 10, wherein in presenting the user with a clickwrap agreement in response to determining that user has not accepted the license terms for the current version, the computer system is further configured:
responsive to determining that the smart contract for the current version does not authorize the user to access the licensed software application, to execute a set of resulting transactions indicated by the smart contract to present the user with the clickwrap agreement requiring the user to accept license terms for the current version of the licensed software application.

12. The computer system of claim 10, wherein in determining whether the smart contract for the current version authorizes the user to access the licensed software application, the computer system is further configured:
to identify an account of the user from the access request; and
responsive to identifying the user, to determine whether a list referenced in the smart contract indicates that the user has accepted license terms for the current version of the licensed software application.

13. The computer system of claim 8, wherein the computer system is further configured:
to collect the access request and a set of resulting transactions into a workflow block;
to attach the workflow block to a local copy of the blockchain; and
to publish the workflow block to the blockchain-based workflow system.

14. The computer system of claim 8, wherein the computer system is further configured:
to identify an account of the user from the access request, wherein the account of the user is a light client account capable of execution on a mobile device; and
to recursively download nodes of a state root hash tree stored at a node in a blockchain network until the account of the user is located.

15. A computer program product for controlling access to a licensed software application, the computer program product comprising:
a non-transitory computer readable storage media;
program code, stored on the computer readable storage media, for receiving an access request from a user that requests access to the licensed software application;
program code, stored on the computer readable storage media, for determining whether a user has accepted license terms for a current version of the licensed software application by querying a version control blockchain;
program code, stored on the computer readable storage media, responsive to determining that user has not accepted the license terms for the current version of the licensed software application, for presenting the user with a clickwrap agreement requiring the user to accept license terms for the current version of the licensed software application; and
program code, stored on the computer readable storage media, responsive to receiving acceptance of the license terms from the user, for recording the user's acceptance of the license terms for the current version of the licensed software application in the version control blockchain.

16. The computer program product of claim 15, wherein each successive version of the licensed software application is associated with a separate version control blockchain.

17. The computer program product of claim 15, wherein each successive version of the licensed software application is associated with a different smart contract encoded on the version control blockchain, wherein the program code for determining whether the user has accepted license terms for the current version further comprises:
program code, stored on the computer readable storage media, for determining whether a smart contract for the current version authorizes the user to access the licensed software application.

18. The computer program product of claim 17, wherein the program code for presenting the user with a clickwrap agreement in response to determining that user has not accepted the license terms for the current version further comprises:
program code, stored on the computer readable storage media, responsive to determining that the smart contract for the current version does not authorize the user to access the licensed software application, for executing a set of resulting transactions indicated by the smart contract to present the user with the clickwrap agreement requiring the user to accept license terms for the current version of the licensed software application.

19. The computer program product of claim 17, wherein the program code for determining whether the smart contract for the current version authorizes the user to access the licensed software application further comprises:
program code, stored on the computer readable storage media, for identifying an account of the user from the access request; and
program code, stored on the computer readable storage media, responsive to identifying the user, for determining whether a list referenced in the smart contract indicates that the user has accepted license terms for the current version of the licensed software application.

20. The computer program product of claim 15, further comprising:
program code, stored on the computer readable storage media, for collecting the access request and a set of resulting transactions into a workflow block;
program code, stored on the computer readable storage media, for attaching the workflow block to a local copy of the blockchain; and
program code, stored on the computer readable storage media, for publishing the workflow block to the blockchain-based workflow system.

21. The computer program product of claim 15, further comprising:
program code, stored on the computer readable storage media, for identifying an account of the user from the access request, wherein the account of the user is a light client account capable of execution on a mobile device; and
program code, stored on the computer readable storage media, for recursively downloading nodes of a state root hash tree stored at a node in a blockchain network until the account of the user is located.
